(19) United States
(12) Patent Application Publication
(10) Pub. No.: US 2014/0293164 A1
(43) Pub. Date: Oct. 2, 2014

(54) TOUCH PANEL AND METHOD FOR ELECTRODE

(71) Applicants: Hyun Jong Kim, Seoul (KR); Young Sun You, Seoul (KR); Kyoung Hoon Chai, Seoul (KR)

(72) Inventors: Hyun Jong Kim, Seoul (KR); Young Sun You, Seoul (KR); Kyoung Hoon Chai, Seoul (KR)

(73) Assignee: LG INNOTEK CO., LTD., Seoul (KR)

(21) Appl. No.: 14/232,499

(22) PCT Filed: Jul. 4, 2012
(86) PCT No.: PCT/KR2012/005315

§ 371 Date: Jun. 11, 2014

(30) Foreign Application Priority Data
Jul. 12, 2011 (KR) 10-2011-0069136

(51) Int. Cl. G06F 3/041

(52) U.S. Cl. CPC G06F 3/0412
USPC 349/12; 427/58; 427/123; 427/125

(57) ABSTRACT

Disclosed are a touch panel and a method for manufacturing the electrode. The touch panel includes a substrate, and a transparent electrode provided on the substrate to detect a contact position. The transparent electrode includes a metallic nanowire having a length of 30 um to 50 um. The method includes preparing a nanowire, coating the nanowire on a substrate, and curing the substrate.

### TECHNICAL FIELD

The embodiment relates to a touch panel and a method for manufacturing the same.

### BACKGROUND ART

Recently, a touch panel, which performs an input function through the touch of an image displayed on a display device by an input device such as a stylus pen or a hand, has been applied to various electronic appliances.

The touch panel may be mainly classified into a resistive touch panel and a capacitive touch panel. In the resistive touch panel, glass is shorted with an electrode due to the pressure of the input device so that a touch point is detected. In the capacitive touch panel, the variation in capacitance between electrodes is detected when a finger of the user is touched on the capacitive touch panel, so that the touch point is detected.

Indium tin oxide (ITO), which has been most extensively used as an electrode of the touch panel, is highly priced, and requires a high-temperature deposition process and a vacuum process. In addition, the ITO is easily struck due to the bending or the curving of a substrate, so that the characteristic of the ITO for the electrode is deteriorated. Accordingly, the ITO is not suitable for a flexible device.

In order to solve the problem, researches and studies on an alternative electrode have been actively carried out.

### DISCLOSURE OF INVENTION

### Technical Problem

The embodiment can provide a touch panel including an electrode representing high transmittance and low resistance.

The embodiment can provide an electrode representing high transmittance and low resistance.

### Solution to Problem

According to the embodiment, there is provided a touch pane. The touch panel includes a substrate, and a transparent electrode provided on the substrate to detect a contact position. The transparent electrode includes a metallic nanowire having a length of 30 um to 50 um. According to the embodiment, there is provided a method for manufacturing the electrode. The method includes preparing a nanowire, coating the nanowire on a substrate, and curing the substrate.

### Advantageous Effects of Invention

The transparent electrode constituting the touch panel according to the embodiment employs a metallic nanowire having a diameter of 30 nm to 60 nm and a length of 30 um to 50 um. Accordingly, the high optical characteristic and the electrical characteristic can be represented. In other words, the metallic nanowire can constitute the electrode while forming a network structure. In this case, the metallic nanowire is formed with a thin thickness and a long length, so that the transmittance and the transparency can be increased, and the resistance can be reduced.

The electrode manufactured through the method for manufacturing the electrode according to the embodiment can maintain high transmittance. In addition, the electrode represents low reflectance, high conductivity, high light transmittance, and low haze. In addition, the electrode represents low sheet resistance, so that the performance of the touch panel having the electrode can be improved.

### BRIEF DESCRIPTION OF DRAWINGS

FIG. 1 is a perspective view schematically showing a touch panel according to a first embodiment;

FIG. 2 is a perspective view schematically showing a touch panel according to a second embodiment;

FIG. 3 is a flowchart showing a method for manufacturing an electrode according to the embodiment; and

FIG. 4 is a flowchart showing a step of preparing a nanowire in the method for manufacturing the electrode according to the embodiment.

### MODE FOR THE INVENTION

In the description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. The thickness and size of each layer (or film), each region, each pattern, or each structure shown in the drawings may be exaggerated, omitted or schematically drawn for the purpose of convenience or clarity. In addition, the size of elements does not utterly reflect an actual size.

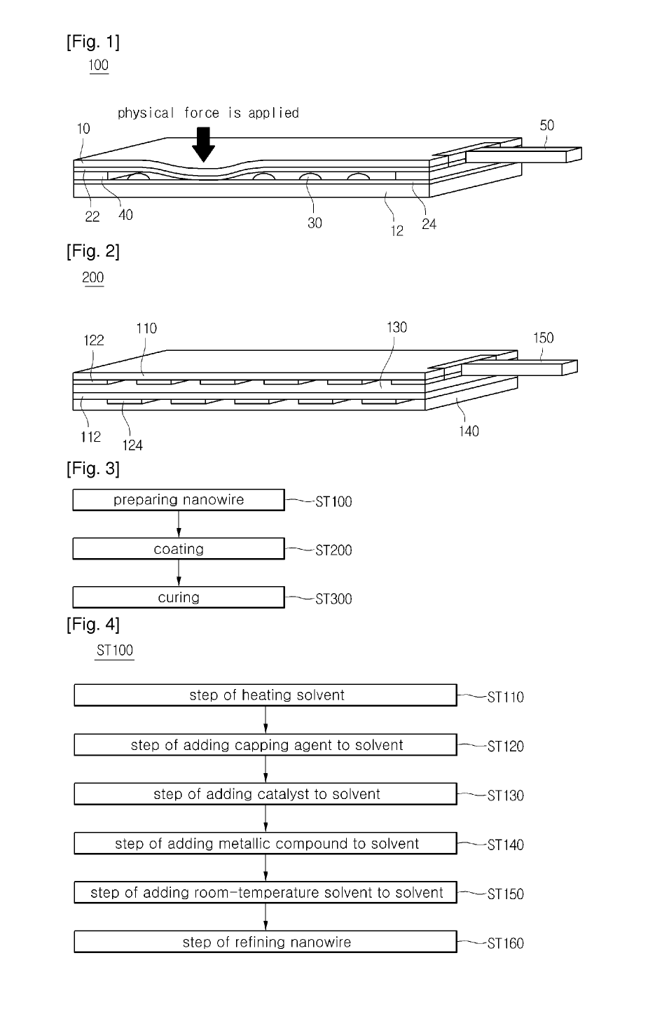

Hereinafter, a touch panel 100 according to a first embodiment will be described in detail with reference to FIG. 1.

The touch panel 100 according to the first embodiment includes a resistive touch panel. The touch panel 100 operates through the contact between transparent electrodes 22 and 24 formed on two substrates 10 and 12.

In detail, the touch panel 100 according to the first embodiment includes the first substrate 10, the second substrate 12 spaced apart from the first substrate 10, the first transparent electrode 22 formed on the first substrate 10, the second transparent electrode 24 formed on the second substrate 12, and a circuit board 50 inserted into the space between the first and second substrates 10 and 12.

The first and second transparent electrodes 22 and 24 are formed on the first and second substrates 10 and 12, respectively, and spaced apart from each other by a dot spacer 30 which includes an insulator and has a spherical shape. If the first transparent electrode 22 and the second transparent electrode 24, which are formed at upper and lower portions, make contact with each other, the resistance value of the sheet resistance between the first and second transparent electrodes 22 and 24 is varied according to the contact position thereof. Current and voltage of the touch panel 100 may be varied depending on the varied resistance, so that the input position may be detected. An adhesion agent 40 is additionally provided in the touch panel 100 to bond the first and second substrates 10 and 12 to each other.

The first and second transparent electrodes 22 and 24 may include a metallic nanowire. In detail, the first and second transparent electrodes 22 and 24 may include a silver nanowire.

The metallic nanowire may have a length of about 30 um or more. In detail, the metallic nanowire may have a length of 30 um to 50 um.

The metallic nanowire may have a diameter of about 60 um or less. In more detail, the metallic nanowire may have a diameter of 30 nm to 60 nm.

When the metallic nanowire is used for the first and second transparent electrodes 22 and 24, the metallic nanowire can represent higher optical and electrical characteristics. In other words, the metallic nanowire can constitute the electrode while forming a network structure. In this case, since the long thin metallic nanowire is formed, the transmittance and the transparency can be increased, and the resistance can be reduced.

Although not shown in accompanying drawings, a liquid crystal panel is additionally positioned on the lower end of the touch panel 100. The liquid crystal panel serves as a display section of the liquid crystal display device. The liquid crystal panel displays an image by adjusting light transmittance of liquid cells injected into the two pieces of glass substrates. The liquid crystal cells adjust the quantity of light transmitted in response to a video signal, that is, a corresponding pixel signal. The touch panel 100 and the liquid crystal panel are bonded to each other to constitute the liquid crystal display device.

Hereinafter, a touch panel 200 according to the second embodiment will be described in detail with reference to FIG. 2. In the following description, the details of structures and components the same as those of the first embodiment or extremely similar to those of the first embodiment will be omitted except for only structures and components making the difference from those of the first embodiment for the purpose of clear and simple explanation.

The touch panel 200 according to the second embodiment is a capacitive touch panel. If an input device such as a finger of a person makes contact with the touch panel 200, capacitance difference is made. The point at which the capacitance difference is made may be detected as a contact position.

In detail, the touch panel 200 according to the second embodiment includes a first substrate 110, a second substrate 112 spaced apart from the first substrate 110, a first transparent electrode 122 formed on the first substrate 110, a second transparent electrode 124 formed on the second substrate 112, and a circuit board 150 inserted into the space between the first and second substrates 110 and 112.

An optically clear adhesive (OCA) 130 formed between the first and second substrates 110 and 112 can stably bond two layers to each other without reducing the light transmittance.

A protective layer 140 may be positioned at the lower end of the second substrate 112. The protective layer 140 may include a scattering prevention layer to prevent fragments from being scattered when the touch panel 200 is broken due to the impact. However, the embodiment is not limited thereto. Accordingly, the protective layer 140 may include an anti-reflective layer to lower the reflectance of visible-band light in order to prevent the glare caused by the reflection or prevent a phenomenon in which a screen image is not viewed.

The first and second transparent electrodes 122 and 124 may include a metallic nanowire. The metallic nanowire may be similar to or identical to the metallic nanowire constituting the touch panel according to the first embodiment which is described above.

Hereinafter, a method for fabricating an electrode according to the embodiment will be described with reference to FIGS. 3 and 4.

FIG. 3 is a flowchart showing the method for manufacturing the electrode according to the embodiment. FIG. 4 is a flowchart showing the step ST100 of preparing a nanowire in the method for manufacturing the electrode according to the embodiment.

Referring to FIG. 3, the method for manufacturing the electrode according to the embodiment includes a step of preparing a nanowire (step ST100), a coating step (step ST200), and a curing step (step ST300).

In the step of preparing the nanowire (step ST100), a nanowire having a diameter of 30 nm to 60 nm, and a length of 30 um to 50 um may be prepared.

In detail, referring to FIG. 4, according to the method for manufacturing the nanowire according to the embodiment may include the step of heating a solvent (step ST110), the step of adding a capping agent to the solvent (step ST120), the step of adding a catalyst to the solvent (step ST130), the step of adding metallic compound in the solvent (step ST140), the step of adding a room-temperature solvent to the solvent (step ST150), and the step of refining the nanowire (step ST160). The steps are not essential steps, parts of the steps may not be performed according to the manufacturing method, and the sequence of the steps may be changed. Hereinafter, each step will be described in more detail.

According to the step ST10 of heating the solvent, the solvent is heated at the reaction temperature suitable for forming the metallic nanowire

The solvent may include polyol. The polyol serves as a mile reducing agent while serving as a solvent of mixing different materials. Therefore, the solvent can form the metallic nanowire by reducing the metallic compound.

The solvent may include the mixture of at least two kinds of materials. For example, the solvent may include first and second solvents. In more detail, the solvent may include the mixture of the first and second solvents.

The first solvent has first reduction power representing weaker reduction power. In more detail, the first solvent has reduction power weaker than that of the second solvent. For example, the first solvent may include ethylene glycol.

The second solvent has second reduction power representing stronger reduction power. In more detail, the second solvent has reduction power stronger than that of the first solvent. In other words, the second reduction power is greater than the first reduction power. The second reduction power represents relatively strong reduction power as compared with the first reduction power, and both of the first and second reduction power may be actually weak.

For example, the second solvent may include propylene glycol. In addition, the first and second solvents may include glycerine, glycerol or glucose.

The ratio of the first solvent to the second solvent may be varied according to the reaction temperature and the type and characteristic of the metallic compound. The volumetric ratio of the first solvent to the second solvent may be in the range of about 1:2 to about 1:4. For example, in order to form the silver nanowire, when the mixture of ethylene glycol and propylene glycol is used as a solvent, the volumetric ratio of ethylene glycol to propylene glycol may be in the range of about 1:2 to about 1:4. In more detail, in the whole mixed solvent, ethylene glycol may have a volumetric percentage of about 20 vol % to about 30 vol %, and propylene glycol may have a volumetric percentage of about 70 vol % to about 80 vol %.

The reaction temperature may be variously adjusted according to the type and the characteristic of the solvent and the metallic compound. In particular, the reaction temperature may be varied according to the used solvents. For example, if a solvent includes the mixture of ethylene glycol and propylene glycol, the reaction temperature may be in the range of about 120° C. to about 126° C.

Thereafter, in the step of adding the capping agent to the solvent (step ST120), the capping agent inducing the forming of the wire is added to the solvent. If reduction for the forming of the nanowire is rapidly performed, metals are aggregated, so that the wire shape may not be formed. Accordingly, the capping agent prevents the metals from being aggregated by properly dispersing materials contained in the solvent.

The capping agent may include various materials. For example, the capping agent may include material selected from the group consisting of polyvinylpyrrolidone (PVP), polyvinyl alcohol (PVA), cetyl trimethyl ammonium bromide (CTAB), cetyl trimethyl ammonium chloride (CTAC), and polyacrylamide (PAA).

Thereafter, in the step of adding the catalyst to the solvent (step ST130), bay salt or refined salt is added as the catalyst. The bay salt or the refined salt includes various metals or halogen element together with NaCl to form a seed used to form a metallic nanowire or to accelerate the reaction of forming the metallic nanowire. The various metals or the halogen element may include Mg, K, Zn, Fe, Se, Mn, P, Br, and I.

For example, the bay salt may further include 80˜90 weight % of NaCl, 3˜12 weight % of H2O, 0.2˜1.2 weight % of Mg, 0.05˜0.5 weight % of K, and 1˜8 weight % of additional elements. The additional elements may include Zn, Fe, Se, Mn, P, Br, and I. Preferably, 4˜8 weight % of the additional elements are provided.

For example, the refined salt may include at least 99 weight % of NaCl, 0.2˜1.0 weight % of H2O, 0.02˜0.04 weight % of Mg, 0.03˜0.08 weight % of K, and at most 0.4 weight % of additional elements. The additional elements may include Zn, Fe, Se, Mn, P, Br, and I. In this case, 0.02˜0.4 weight % of additional elements may be provided. As described above, although the content of additional elements, such as Mg, K, and Br, of the refined salt is less than the content of the additional elements, such as Mg, K, and Br, of the bay salt, since the refined salt contains the additional elements at a predetermined ratio or more, the refined salt can accelerate the forming of the metallic nanowire.

As described above, since the bay salt or the refined salt contains Mg, K, Zn, Fe, Se, Mn, P, Br, and I at a predetermined ratio together with NaCl, the reaction of forming the metallic nanowire can be easily performed. In particular, Cl, Br, and I among the halogen elements may serve as main elements to form the nanowire. In addition, Mg may serve as an important promoter to reduce metal (e.g., Ag) of the metallic compound. The composition is limited so that the elements can properly perform the function of a catalyst.

In addition, as described above, if the refined salt or the bay salt is used, it is unnecessary to add the above metals or the halogen elements. Accordingly, only the refined salt or the bay salt is added, so that the manufacturing process can be simplified.

Thereafter, in the step of adding the metallic compound to the solvent (step ST140), a reaction solution is formed by adding the metallic compound to the solvent.

In this case, the metallic compound melted in a separate solvent may be added to the solvent having the capping agent and the catalyst. The separate solvent may include material identical to or different from material in the solvent used in the initial stage. The metallic compound may be added after a predetermined time elapses from a time in which the catalyst is added. Accordingly, a desirable reaction temperature can be stabilized.

In this case, the metallic compound includes a compound including metal used to manufacture a desirable metallic nanowire. In order to form a silver nanowire, the metallic compound may include AgCl, AgNO₃ or KAg(CN)₂.

As described above, if the metallic compound is added to the solvent having the capping agent and the catalyst, reaction occurs so that the forming of the metallic nanowire is started.

According to the present embodiment, the capping agent may be added by the content of 60 weight part to 330 weight part with respect to 100 weight part of the metallic compound such as AgCl, AgNO₃ or KAg(CN)₂. If the capping agent is added by the content of less than 60 weight part, the aggregation cannot be prevented sufficiently. If the capping agent is added by the content of more than 330 weight part, metallic nanoparticles may be formed in a spherical shape or a cube shape, and the capping agent remains in the metallic nanowire so that the electrical conductivity may be degraded.

In addition, the catalyst may be added by the content of 0.005 weight part to 0.5 weight part with respect to 100 weight part of the metallic compound. If the catalyst is added by the content of less than 0.005 weight part, reaction may not be sufficiently accelerated. In addition, if the catalyst is added by the content of more than 0.5 weight part, the reduction of silver is rapidly performed, so that silver nanoparticles may be created, or the diameter of the nanowire may be increased and the length of the nanowire may be shorted. In addition, the catalyst remains in the manufactured metallic nanowire so that the electrical conductivity may be degraded.

Thereafter, in the step of adding the room-temperature solvent to a reaction solution (step ST150), the room-temperature solvent is added to the solvent in which reaction is started. The room-temperature solvent may include material identical to or different from material contained in the solvent used in the initial stage. For example, the room-temperature solvent may include polyol such as ethylene glycol and propylene glycol.

As the solvent, in which the reaction is started, is continuously heated in order to maintain the constant reaction temperature, the temperature may be increased in the process of the reaction. As described above, the reaction temperature may be more constantly maintained by temporarily degrading the temperature of the solvent by adding the room-temperature solvent to the solvent in which the reaction is started.

The step of adding the room-temperature solvent (step ST150) may be performed one time or several times by taking the reaction time, and the temperature of the reaction solution into consideration.

Thereafter, in the step of refining the nanowire (step ST160), the metallic nanowire is refined and collected in the reaction solution.

In more detail, if acetone serving as a non-polar solvent is added to the reaction solution rather than water, the metallic nanowire is deposited at the lower portion of the solution due to the capping agent remaining on the surface of the metallic nanowire. This is because the capping agent is not dissolved in the acetone, but aggregated and deposited although the capping agent is sufficiently dissolved in the solvent. Thereafter, when the upper portion of the solution is discarded, a portion of the capping agent and nanoparticles are discarded.

If distill water is added to the remaining solution, metallic nanowire and metallic nanoparticles are dispersed. In addition, if acetone is more added, the metallic nanowire is deposited, and the metallic nanoparticles are dispersed in the upper portion of the solution. Thereafter, if the upper portion of the solution is discarded, a part of the capping agent and the aggregated metallic nanoparticles are discarded. After collecting the metallic nanowire by repeatedly performing the above processes, the metallic nanowire is stored in the distill water. The metallic nanowire can be prevented from being re-aggregated by storing the metallic nanowire into the distill water.

As described above, in the step of preparing the nanowire (step ST100), the metallic compound is reduced by using the first and second solvents having reduction powers different from each other to form the metallic nanowire.

In particular, the second solvent representing stronger reduction power may form the long metallic nanowire, and the first solvent representing weaker reduction power may form the thin metallic nanowire. In other words, a long thin metallic nanowire may be formed by the first and second solvents. Therefore, in the step of preparing the nanowire (step ST100), a metallic nanowire having a great aspect ratio can be provided. Therefore, in the step of preparing the nanowire (step ST100), the metallic nanowire having the great aspect ratio can be provided. In other words, the nanowire having a diameter of 30 nm to 60 nm and a length of 30 um to 50 um can be prepared through the step of preparing the nanowire (step ST100).

Thereafter, in the coating step (step ST200), the nanowire can be coated on the substrate.

Before performing the coating step (step ST200), a step of preparing electrode material may be further provided. In the step of preparing the electrode material, the electrode material may be prepared by dispersing the nanowire in water or ethanol. The electrode material may additionally include viscosity controlling agent and surfactant.

Thereafter, in the coating step (step ST200), the electrode material may be coated on the substrate. Accordingly, the nanowire can be coated on the substrate in the state that the nanowire is uniformly dispersed without being aggregated. Therefore, the transmittance of the electrode including the nanowire can be improved, and the resistance thereof can be reduced.

In this case, 0.3 weight % to 0.5 weight % of nanowire may be contained with respect to the electrode material. If 0.3 weight % or less of nanowire is contained with respect to the electrode material, the electrical conductivity may be reduced. If 0.5 weight % or more of nanowire is contained with respect to the electrode material, the nanowires are aggregated to lower the transmittance.

In coating step (step ST200), a dip coating scheme may be performed. The dip coating scheme is one of coating schemes, and refers to a scheme of obtaining a coating film by baking a coated material at a desirable temperature after forming a precursor layer on the surface of the coated material by dipping the coated material into a coating solution or slurry.

The dip coating may be performed at a rate of 1 mm/s to 3mm/s. In detail, after dipping the substrate into the electrode material, the dipping coating rate may be raised to the range of 1 mm/s to 3mm/s.

However, the embodiment is not limited thereto. Accordingly, the coating step ST200 may be performed through various coating schemes such as a spin coating scheme, a flow coating scheme, a spray coating scheme, a slit die coating scheme, and a roll coating scheme.

Thereafter, in the curing step (ST300), the coated substrate can be cured.

Thereafter, after performing the coating step (ST200), the substrate is dried under the atmosphere. Then, the curing temperature may be raised at a rate of 2° C./min to 10° C./min. Thereafter, the substrate may be cured at the temperature of 100° C. to 150° C. for 10 min to 50 min. The electrode manufactured through the method for manufacturing the electrode can maintain high transmittance. In addition, the electrode represents low reflectance, high conductivity, high light transmittance, and low haze. In addition, the electrode represents low sheet resistance, so that the performance of the touch panel having the electrode can be improved.

Hereinafter, the embodiment of the disclosure will be described in more detail. However, the embodiment is provided only for the illustrative purpose of the disclosure, and the disclosure is not limited thereto.

### Embodiment

About 200 ml of a solvent in which ethylene glycol and propylene glycol are mixed with each other at the ratio of about 1:3 was prepared. The solvent was heated at the temperature of about 126° C. Then, after adding and melting 6.68 g of polyvinylpyrrolidone into the solvent, 0.1 g of KBr and 0.5 g of AgCl were added. Thereafter, about 2.2 g of AgNO3 and 0.5 g of AgCl were melted in 100 ml of mixed solution of ethylene glycol and propylene glycol (mixed with each other at the ratio of about 1:3) and added into the mixed solution of polyvinylpyrrolidone (PVP), KBr, and the solvent. Thereafter, the silver nanowire had been formed by continuously performing the reaction for about one hour.

After adding 500 ml of acetone to the solution which was had been subject to the reaction, the upper portion of the solution having ethylene glycol, propylene glycol, and silver nanoparticles dispersed therein was discarded.

The aggregated silver nanowires and the silver nanoparticles had been dispersed by adding 100 ml of distilled water. In addition, after additionally putting 500 ml of acetone, the upper portion of the solution having ethylene glycol, propylene glycol, and silver nanoparticles dispersed therein had been discarded. After repeatedly performing the above processes three times, the result was stored in 10 ml of distill water.

The electrode material was prepared by dispersing the silver nanowire into the ethanol. In this case, 0.3 weight % of silver nanowire was contained with respect to the electrode material. After dipping a substrate into the electrode material, the substrate was subject to the dip coating scheme at the rate of about 2 mm/s. After drying the coated substrate under the atmosphere, the substrate was cured at a temperature of about 150° C.

### COMPARATIVE EXAMPLE

Indium tin oxide (ITO) was deposited on the substrate.

The characteristics of electrodes formed according to the embodiment and the comparative example were measured. The embodiment and the comparative example were measured in terms of haze, the total transmittance, transmittance, and resistance, and the results thereof were shown in table 1.

TABLE 1

| | Comparative | |
|---|---|---|
| | Example | Embodiment |
| Haze (%) | 1.16 | 0.86 |
| Total Transmittance (%) | 89.56 | 90.71 |
| Transmittance (%) | 89.3 | 90.2 |
| Resistance (Ω) | 286 | 113 |

Referring to FIG. 1, according to the embodiment, 1.0% or less of haze was measured at the range of 400 nm to 700 nm, so that the transmittance is improved when comparing with that of the comparative example. In addition, according to the embodiment, 90% or more of the total transmittance and the transmittance were measured at the range of 400 nm to 700 nm, so that the total transmittance and the transmittance were improved when comparing with the comparative example. In addition, the resistance of the embodiment was at least 100Ω lower than the resistance of the comparative example, so that an electrode having a low electrode can be realized.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A touch panel comprising:
a substrate; and
a transparent electrode provided on the substrate to detect a contact position, wherein the transparent electrode includes a metallic nanowire having a length of 30 um to 50 um.

2. The touch panel of claim 1, wherein the metallic nanowire has a diameter of 30 nm to 60 nm.

3. The touch panel of claim 2, wherein the metal includes silver.

4. A method for manufacturing an electrode, the method comprising:
preparing a nanowire;
coating the nanowire on a substrate; and
curing the substrate.

5. The method of claim 4, wherein the preparing of the nanowire comprises a step of forming a metallic nanowire by adding a metallic compound in a first solvent having a first reduction power and a second solvent having a second reduction power greater than the first reduction power and heating the metallic compound.

6. The method of claim 5, wherein the first and second solvents include glycol.

7. The method of claim 6, wherein the first solvent includes ethylene glycol, and the second solvent includes propylene glycol.

8. The method of claim 7, wherein a volumetric ratio of the first solvent to the second solvent is in a range of 1:2 to 1:4.

9. The method of claim 5, wherein the metallic compound includes silver.

10. The method of claim 4, wherein the nanowire has a diameter of 30 nm to 60 nm and a length of 30 um to 50 um.

11. The method of claim 5, wherein the first and second solvents are heated at the temperature of 120° C. to 126° C.

12. The method of claim 4, further comprising a step of preparing an electrode material a solution by dispersing the nanowire into water or ethanol, before the coating of the nanowire.

13. The method of claim 12, wherein the electrode material a solution includes a viscosity controlling agent and a surfactant.

14. The method of claim 12, wherein 0.3 weight % to 0.5 weight % of the nanowire is contained with respect to the electrode material a solution.

15. The method of claim 4, wherein, in the coating of the nanowire on the substrate, one of a dip coating scheme, a flow coating scheme, a spray coating scheme, a slit die coating scheme, and a roll coating scheme is performed.

16. The method of claim 15, wherein the dip coating scheme is performed at a rate of 1 mm/s to 3 mm/s.

17. The method of claim 4, wherein the curing of the substrate is performed at a temperature of 100° C. to 150° C.

18. The touch panel of claim 1, wherein the transparent electrode includes a first transparent electrode and a second transparent electrode causing the variation in capacitance with the first transparent electrode.

19. The touch panel of claim 18, wherein the first transparent electrode and the second transparent electrode include a dispersion medium and nanowire dispersed in the dispersion medium.

20. The touch panel of claim 19, wherein 0.3 weight % to 0.5 weight % of the nanowire is contained with respect to the dispersion medium.
